(19) United States
(12) Patent Application Publication
(10) Pub. No.: US 2004/0076729 A1
(43) Pub. Date: Apr. 22, 2004

(54) Cheese product and method of making

(75) Inventor: Frank J. Jaskulka, Andover, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Land O'Lakes, Inc.

(21) Appl. No.: 10/342,139

(22) Filed: Jan. 14, 2003

Related U.S. Application Data
(60) Provisional application No. 60/420,367, filed on Oct. 22, 2002.

(51) Int. Cl. A23C 19/00

(52) U.S. Cl. 426/582

(57) ABSTRACT

A method increases moisture level to produce a process cheese-type product with additional moisture without substantially changing organoleptic or physical properties of the cheese of cheese product. The method includes comminuting the cheese or cheese product and then adding an incremental amount of additional moisture thereby increasing the overall moisture level above the original moisture level of the cheese or cheese product while subjecting the cheese or cheese product to a shear rate of at least 500 reciprocal seconds.

### CROSS-REFERENCE TO RELATED APPLICATION(S)

Applicant claims the priority date of U.S. Provisional Application 60/420,367, filed Oct. 22, 2002.

### FIELD OF THE INVENTION

The present invention includes a method for making process cheese-type products, and products made by the process, by utilizing high shear in relation to the moisture content. In particular, the present invention relates to a method of making selected process cheese-type products through the utilization of high shear so that additional moisture can be added while retaining the organoleptic and physical properties of the process cheese-type products as if the additional moisture had not been added.

### BACKGROUND OF THE INVENTION

As used herein, the term “process cheese-type products,” are defined to include those products known and referred to as “pasteurized process cheese,” “pasteurized process cheese food,” “pasteurized process cheese spread,” and “pasteurized process cheese product.” “Process cheese-type products” also includes products resembling process cheese, process cheese food, process cheese spread, and process cheese product regardless of whether or not they meet the U.S. Federal Standards of Identity for any of the above products in that they may contain ingredients not specified by such Standards, such as vegetable oil, anhydrous milk fat, or milk protein concentrate, or may/may not meet the compositional requirements of such Standards of Identity. Process cheese-type products also include products having flavor and texture similar to those of a process cheese-type product irrespective of the ingredients or manufacturing steps employed, and irrespective of whether the Standards of Identity have been met. In addition, this invention is applicable to fat-free, reduced-fat or low-fat process cheese-type products.

U.S. Pat. No. 5,350,595 succinctly describes “pasteurized process cheese” as a product comprising a blend of cheeses to which an emulsifying agent, usually an emulsifying salt, and possibly acids, are added. The mixture is then worked and heated into a homogeneous plastic mass. On cooling, this mass displays the functional and organoleptic properties typical of pasteurized process cheese falling within the U.S. Federal Standards of Identity.

The term “pasteurized process cheese food” refers to a product which is prepared from the same materials and the same processes used for manufacture of process cheese. However, cheese food generally has dairy ingredients added thereto, such as cream, milk, skimmed milk, whey or any of these from which part of the water has been removed (e.g., concentrated skimmed milk). The moisture level in process cheese food is generally higher than that of process cheese and may be up to about 44%. Fat is present at a level of not less than 23%.

The term “pasteurized process cheese spread” refers to a product which is similar to cheese food, in the sense that it can contain the indicated dairy ingredients. Process cheese spread, however, may have a moisture level as high as 60%. The minimum fat level for pasteurized process cheese spread is 20%.

The phrase “high shear” is used often in cheese processing. But, in most cases, the high shear disclosed is much less than the shear rate that is being imposed on the blend of ingredients in the present invention. Although high shear is discussed is prior patents and literature, in most cases, this shear rate is significantly below the shear rate used in this invention. In other cases, high shear rate has been utilized to create a stable emulsion. However, the use of high shear levels as high as disclosed in this invention have not been applied to the manufacture of process cheese-type products; in addition, prior art neither discloses nor contemplates tha application of high shear in combination with increased moisture levels in the manufacture of process cheese-type products.

Bixby et al., in U.S. Pat. No. 4,444,800, teach the use of high shear agitation to generate a non-cultured, simulated cheese product although the use of high shear was not used to incorporate higher levels of moisture into the product while maintaining the texture, body and eating quality of the resulting cheese.

U.S. Pat. No. 6,183,804-B1 defines high shear to mean a sufficiently high shear to produce a stable, monodispersed fresh cheese. Again, the application of high shear was not intended to increase the moisture content of the product.

Renda et al. (1997. Journal of Dairy Science. 80:1901-1907) defines high screw speed, used in the production of low moisture part-skim Mozzarella cheese, as a mixer screw speed of 19 rpm, but there was no attempt to raise the moisture content of the product because of the application of high shear.

Bell et al. (U.S. Pat. No. 3,922,374) also refers to high shear mixing to create food resembling pasta filata, cheddar, or pasteurized process cheese by using high shear mixing to mix and react calcium hydroxide and fat. The most satisfactory apparatus known to the applicants was the Littleford-Lodige high shear mixing vessels sold by Littelford Brothers, Inc., Cincinnati, Ohio, USA, although no specific shear rate was defined for this process. Moisture increase is not described in the patent.

In U.S. Pat. No. 5,350,595, Hockenberry et al. define the shear history for a method for continuous manufacture of process cheese-type products. Here, the mechanical shear required to facilitate heat transfer into uncooked cheese particles was required to be at least about 5 reciprocal seconds for a major portion of the process cheese-type formulation, preferably greater than about 70% by weight. If the shear is excessive, it is noted, damage will be done to shear-sensitive components in the finished product. The maximum shear that a minor portion of the process cheese-type formulation, preferably less than about 10% ofthe product, should be subjected to is about 1000 reciprocal seconds; preferably, this portion of the product should be subjected to shear less than about 500 reciprocal seconds. The use of shear coupled with added moisture was not evaluated.

Wirchansky and De Vito (Canadian Patent 542,392; U.S. Pat. No. 4,749,584) define “high shear blending” to mean conditions sufficient to impart the energy needed to disrupt the cheese curd such that intimate contact is obtained between the disrupted curd and the other ingredients. It was found that a conventional blender, such as a Hobart blender, was sufficient to accomplish this purpose. The resulting product is a low-fat cheese spread. High shear was not used to increase the moisture content of this product, however.

Laye et al. (U.S. Pat. No. 6,303,160 B1) discuss the application of high shear (via homogenization) of a coarse emulsion to form a fine emulsion with a typical mean particle size of about 1.5 to 5 microns. The result is a high moisture cream cheese with increased firmness. No attempt was made to increase the moisture content of the finished product.

In addition, the art teaches about the deleterious effects of excessive shear on process cheese-type products. In the book entitled “Process Cheese” by Zehren and Nusbaum, both employees of Schreiber Foods, Inc. of Greenbay, Wis., it is stated that overly vigorous agitation (such as that imparted by the high shear of the inventive process) results in over-emulsification causing an undesirable firm body and often times reduced melt.

U.S. Pat. No. 5,350,595 cautions that too much agitation during heating results in over-emulsification and a process cheese-type product having undesirable body characteristics. In order for process cheese-type products to have the correct texture, flavor and meltability attributes, they must undergo a specific temperature and shear history. If the shear from agitation is excessive, the fat becomes over-emulsified causing defective texture, i.e., the process cheese-type product becomes too firm and rubbery and it will have restricted melting ability in applications such as hot sandwiches. Hence, the amount of time the process cheese-type product experiences at any given condition of shear and temperature are critical to the finished product attributes.

In the final report to the Wisconsin Milk Marketing Board (Jaskulka 1994 Development of Pasteurized Blended American Cheese Possessing the Characteristics of Pasteurized Process American Cheese) the effect of high shear on Pasteurized Process Blended American cheese was reported. The use of increased shear rate, via the Stephan cooker, created a product that lacked essential features of acceptable process cheese-type products in that the material produced was difficult to slice and was no longer melt-able.

Thus, if high shear alone is applied in the production of process cheese-type products, the product becomes too firm, and it does not have sufficient melting characteristics. In order to produce process cheese-type products which are lower in fat and caloric content and more economical to manufacture, it is desirable to increase the content of water in process cheese-type products; however, this has not been made possible by the prior art. If moisture is added to process cheese-type products in a conventional process, the end result is unacceptable in that it fails to retain the organoleptic and performance characteristics of the products being imitated. The resulting product can be hard to slice, is significantly firmer, it melts too much or too quickly, and has an unsuitably soft and gummy consistency. We have found, surprisingly, that the coupling of the two, the addition of moisture and the processing under high shear, provides a unique product.

### BRIEF SUMMARY OF THE INVENTION

The present invention includes a method of increasing moisture level in a cheese or cheese product having a specified moisture level and without substantially changing the organoleptic or physical properties of the cheese or cheese product. The method may include comminuting a selected amount of cheese or cheese product and then adding an incremental amount of additional moisture thereby increasing the overall moisture level above the specified moisture level and subjecting the cheese or cheese product with the additional moisture to a shear rate of at least 500 reciprocal seconds. The resulting increased-moisture process cheese-type product may be used as such or blended with other foods such as conventional moisture process cheese-type products.

### BRIEF DESCRIPTION OF THE DRAWINGS

The drawing is a flow diagram of the process of the present invention.

### DETAILED DESCRIPTION OF THE INVENTION

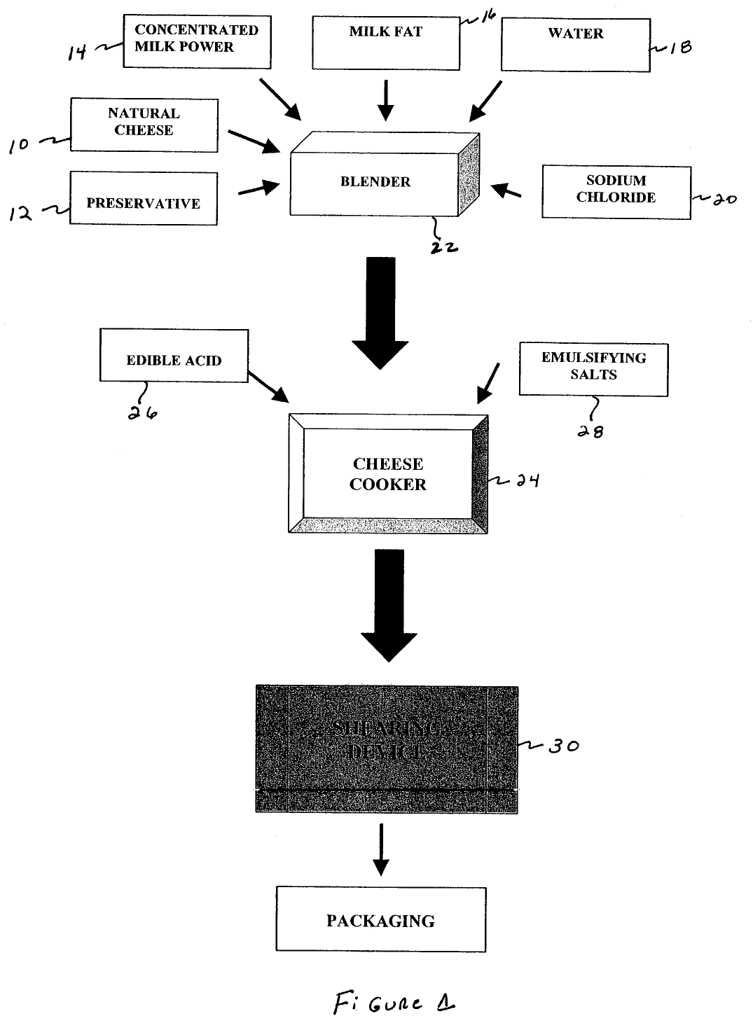

The enclosed flow diagram labeled as FIG. 1 depicts a preferred embodiment of the process of the present invention. As illustrated in FIG. 1, the beginning of the preferred embodiment includes a typical process cheese-type product process. The present invention can be applied to any of the standardized products such as process cheese, process cheese food, process cheese spread, but also to other types of products to which the standards of identity do not apply including imitation cheese products, substitute cheese products, and simulated cheese products. Collectively, all of these will be called process cheese-type products for purposes of this application. One primary difference between each of the above-mentioned products is moisture level. The moisture level increases when comparing process cheese to process cheese food to process cheese spread. As the moisture level is increased, the cheese product takes on different organoleptic and physical characteristics. This invention permits an increase in moisture level while retaining the organoleptic and performance properties of the process cheese-type product as if the additional moisture had not been added. At the same time, increases in moisture content, through the use of high shear, can also be applied to any process cheese-type product whether or not it meets the Standards of Identity and/or is nutritionally equivalent to the product it replaces.

For the purposes of this application, the products processed under high shear with additional moisture are also referred to as “added moisture cheese products” and include products which meet, or do not meet, the Standards of Identity.

Referring to FIG. 1, regular natural cheese 10 may be ground up as is typically done in a process cheese process. Depending on the type of product being manufactured, various ingredients are combined together in a blender including preservatives along with concentrated milk proteins, milk fat or oil, water, and sodium chloride (salt). A sample from the blender is analyzed to determine if the mixing goals have been achieved with respect to product composition and uniformity.

The natural cheese may be ground to a fine particulate size before blending. In actuality, it can be ground to ribbon-like pieces about an inch or so long. This process is referred to as “comminuting” which means to reduce the size of the cheese particles, to reduce in size and minimize the presence of hard rind, and to disrupt the surface membrane of fresh stirred curd to increase the surface area to allow intimate mixing with emulsifiers and other ingredients and to permit uniform heat penetration during the cooking process. Depending on the type of product being manufactured, part or all of the cheese can be replaced by various components including concentrated or unconcentrated milk proteins, milk fat (concentrated or anhydrous), oil, and moisture. The additional moisture of the inventive process can be supplied in the reconstitution of dried dairy ingredients. Although the preferred embodiment illustrated in FIG. 1 uses cheese as the starting material, it will be evident to those skilled in the art that the process is not limited to conventional cheese, but is suitable for imparting desirable characteristics, and increased moisture, to any cheese-like combination of ingredients, and integration into dairy processes. For example, an acid curd or coagulum or concentrated matrix formed by removal of water from milk or a combination of dairy and other food ingredients, such as by diafiltration, ultrafiltration, or reverse osmosis, or finished process cheese-type products can be subjected to the inventive process, to impart desired properties and increased moisture content.

The mixture after blending is conveyed into a suitable apparatus for heating the mixture. Acid and emulsifying salts may be added and heat and steam are applied to the mix. Preferably, the heating is effected in a conventional processed cheese laydown cooker wherein heating is effected by steam injection. Heating can also be performed in a jacketed mixer, such as a Groen kettle. The temperature and residence time in the cheese cooker are such that microorganisms that could lead to spoilage or food poisoning are killed. In addition, the temperature and residence time are sufficient to inactivate the enzymes found in the natural cheese so that the product does not continue to age. One example of a suitable time and temperature combination is 160° F. for 30 seconds.

After the cheese cooker, the heated blend is in a flowable condition.

In one embodiment of the improved process, the heated blend is conveyed to a shearing device as described below. The application of high-shear can be employed as batch, semi-continuous, or continuous processes. Moisture can be added to the heated blend as it is transferred to the shear device.

One suitable high shear device is a Stephan cooker made by A. Stephan U. Sohne GmbA & Company of Hameln, Germany. The Stephan cooker is used commonly in the process cheese industry although it is not used commonly in the United States. Another suitable high shear device that has been used is a CR Mixer made by Waukesha Cherry-Burrell Products of Delavan, Wis. which has more flexibility than the Stephan cooker with respect to the shear rate applied to the molten cheese product. A third suitable high shear device is the Boston Shear Pump made by Admix, Inc. of Manchester, N.H.

The Stephan cooker includes a large stainless steel mixing bowl and is a batch-type mixer in which a batch of the mix is placed therein and processed using a selected shear rate, and then taken out. The Stephan cooker used in this invention holds approximately 50 lbs. of mixture and is opened from the top and at its very bottom contains a very sharp two piece agitator with cutting blades. The drive motor to rotate the Cutting blades is mounted below the mixing bowl. The blades pick up the cheese and other ingredients at 1,500 rpm or 3,000 rpm and comminute the material. Steam is injected directly into the mixture of comminuted cheese and ingredients through three stainless steel jets located in the bottom of the bowl. This steam can be used to provide the added moisture of the invention. A mixing baffle, which is operated manually or mechanically, helps rotate the material towards the cutting blades.

The Stephan cooker can be used for grinding cheese from a big block of cheese, cutting the block into small ribbon-like pieces. The Stephan cooker machine is unique in that it can eliminate the need for a separate grinder to comminute the cheese.

The CR Mixer, made by Waukesha Cherry Burrell, Delevan, Wis., USA, is of a tube construction and is fed by a positive displacement pump that feeds the mix through a stainless steel liner having a series of pins. As the mix is forced through the pins, shear is generated. The CR Mixer has two sets of pins, one set that is static, and the other set that is moving. The mix exits the stainless steel liner or tube having been processed at a high shear rate.

The primary feature of the CR Mixer is the ability to make the materials in process pass through a recycle or multi-pass mixing zone of intermeshing pins not once, but many times during their “residence” within the mixer. The number of times the material is returned or recycled to and through the multi-pass zone is controlled by the rotor speed and product consistency. At higher rotor speeds, the material in process is made to circulate and recirculate more times through the multi-pass zone, regardless of the net flow of product. Mixing efficiency can be further enhanced by imposing pressure by a valve in the mixer discharge line.

The Boston shear pump, manufactured by Admix, Manchester, N.H., USA, is in principal built like a centrifugal pump except instead of an impeller a rotor and stator are used to comminute and transport the material. Shear pumps are also known as wet mills, high shear mixers, and rotor stator homogenizers. In shear pumps, the construction of the rotor and stator may differ which would affect shear rate.

The additional moisture of the invention can be incorporated into the process cheese-type product after the shear has been applied. After shearing, the molten process cheese-type product is withdrawn from the shearing device and packaged. Packaging may take any one of a number of forms, for example, loaves or jars. Alternatively, the molten process cheese-type product may be formed into slices by distributing the product upon the surface of a cooled rotating chill roll in the form of a thin layer which solidifies into a sheet which is removed from the chilled surface of the roll, cut into strips and subsequently into slices followed by packaging of the sliced process cheese-type product.

In using these pieces of equipment, it has been discovered that the high shear used in this invention is not necessarily associated with just one instrument, but any one of a number of shear devices could provide the high shear rate needed. As another example, homogenization of process cheese-type products would result in the application of high shear to the product. Therefore, the invention is not dependent on the physical construction of the device but is dependent on particular shear rates experienced by the material. The high shear rate can be calculated from the particular instrument being used.

The present invention uses shear rate to create a product that was thought not possible to make. It is surprising that utilizing high shear with additional moisture produces a process cheese product (added moisture cheese product or process cheese-type product) that retains its original physical and organoleptic properties.

To date, high shear has not been used to increase the moisture content of a process cheese-type product while retaining the organoleptic and performance properties of the process cheese-type product as if the additional moisture had not been added. While not wishing to be bound by theory, it is believed that the use of a high shear rate changes the emulsion of the blend of fat and water phases so that the final product holds more moisture while retaining the product characteristics typical of the product that is being imitated (the product before the additional moisture).

As far as an upper limit of shear rate, the amount of shear applied will depend somewhat on the amount of additional water being placed into the product. If incrementally smaller amounts of moisture are added, then, in general, smaller amounts of shear are needed, and likewise, if a greater amount of moisture is added, then, in general more shear will be required. However, it has also been discovered that the coupling of moisture and high shear to make an acceptable product is a robust process. That is, a relatively wide range of added shear can produce process cheese-type products that retain their original physical and organoleptic properties. The amount of moisture incorporation is directionally a function of shear rate. The minimum amount of shear required for successful product development with this invention is at least approximately 500 reciprocal seconds. Preferably, the shear rate that is necessary for successful product development ranges upward from approximately 1400 reciprocal seconds. A typical amount of additional moisture addition is at least 0.10% on a weight basis. Preferably, 1 to 4% additional moisture is added on a weight basis. However, greater amounts of moisture could also be added.

Stated otherwise, this invention creates a process cheese-type product which imitates pasteurized process cheese, pasteurized process cheese food, pasteurized process cheese spread, or pasteurized process cheese product since it has the same organoleptic and physical characteristics as the mentioned process cheese-type products but with additional moisture.

Viscosity agents may be dispersed within the process cheese-type product. Such viscosity agents include gums or starches. However, it is not presently understood whether additional moisture would be bound by the addition of a gum or starch in combination with high shear.

Some of the organoleptic and physical characteristics of the imitation process cheese produced in accordance with this invention are as follows:

### Total Moisture

The total moisture (water) in the added moisture process cheese-type product produced with this invention ranges from 39.8% to 50.0%. The total moisture is measured according to the Official Methods of Analysis of the Association of Analytical Chemists (AOAC) International, 13th edition, 1980; Section 16.233: “Method I (52)-Official Final Action,” under the heading “Moisture”.

### Total Fat

The added moisture process cheese products made according to this invention have a total fat ranging from 21.00% to 33.00%. The fat is measured by Official Methods of Analysis of the Association of Official Analytical Chemists (AOAC) International, 13th edition, 1980; Section 16.255: “Fat (60)—Official Final Action”.

### Melt

The added moisture process cheese products of this invention have a finished product melt that ranges from a melt test score ‘1’ to ‘6’ according to either one of two melt tests. The first is a Schreiber melt test which includes the use of a circular, 39.5 mm diameter cookie cutter to cut a 3/16 inch thick disc of cheese. This disc is placed in a covered 15×100 mm thin wall Pyrex petri dish and heated in a forced draft oven that was preheated to 232° C. (450° F.). The sample was removed after 5 minutes and cooled for 30 minutes at room temperature. The spread of the sample is then measured on a melt test score sheet of 11 concentric rings at an evenly spaced distance of 3.25 mm between each ring from the edge of the cheese product sample. The numerical value given in the melt test score indicates how many rings enclose the melted spread of the sample.

The other melt test utilized is adopted by the United States Department of Agriculture and is a variation of the Schreiber melt test. The added moisture cheese product is tempered to 45-55° F. A circular disc ¼ inch thick and 1.5 inch in diameter is cutout with a cheese slicer or a cooker cutter and placed in a covered glass petri dish. An oven is preheated to 400° F. and the sample is heated for exactly 10 minutes and removed from the oven. After the sample has cooled, the spread out of the melted cheese is measured on a cheese melting scale, which has 6 concentric rings spread out starting from the edge of the original 1.5 inch diameter cheese disc. The concentric rings are spaced 3/16 inch between rings.

### Penetrometer

The added moisture process cheese products have penetration depths of greater than 80 mm using a penetrometer AACC Method 58-14; American Association of Cereal Chemists, consistency-penetration method (10th edition).

### Slice/Separation

The added moisture process cheese product produced in accordance with this invention is sliced freely. The added moisture cheese product did not adhere to the knife and fell away from the knife and was not sticky nor did it show tearing or mealiness. The procedure used is described on pages 302-304 of “Process Cheese” by Zehren and Nusbaum, 1992. Ideally, a slicer blade as in a commercial reciprocating carriage having a spinning disc is used.

Although the present invention has been described with reference to preferred embodiments, workers skilled in the art will recognize that changes may be made in form and detail without departing from the spirit and scope of the invention.

1. A method of increasing moisture level in a process cheese-type product cheese having an initial specified moisture level and without substantially changing organoleptic or physical properties of the process cheese-type product, the method comprising:
providing an incremental amount of additional moisture to process cheese-type product ingredients to increase the overall moisture above the initial specified moisture level of the cheese or cheese product; and
subjecting the process cheese-type product with the additional moisture to a shear rate of approximately 500 reciprocal seconds.

2. The method of claim 1 wherein the shear rate is at least approximately 1400 reciprocal seconds.

3. The method of claim 1 wherein the incremental amount of additional moisture is at least 0.10 percent based on the total weight of the process cheese-type product.

4. The method of claim 1 wherein the incremental amount of additional moisture is approximately 1 to 4 percent based on the total weight of the process cheese-type product.

5. The method of claim 2 wherein the incremental amount of additional moisture is at least 0.10 percent based on the total weight of the process cheese-type product.

6. The method of claim 2 wherein the incremental amount of additional moisture is 1 to 4 percent based on the total weight of the process cheese-type product.

7. A process cheese-type product produced by the method of claim 1.

8. A process cheese-type product containing from 0.1 to 100% of the material produced by the method of claim 1.

9. A process cheese-type product wherein the material of claim 7 is combined with unsheared process cheese-type product components to make a process cheese-type product.

10. A method of increasing the ability of a process cheese-type product to accept additional moisture without a substantial change in organoleptic or physical properties, the method comprising subjecting the process cheese-type product to a shear rate of at least approximately 500 reciprocal seconds wherein said additional moisture is added at any point in the process.

11. The method of claim 10 wherein the shear rate is at least approximately 1400 reciprocal seconds.

12. The method of claim 10 wherein the additional moisture is at least 0.10 weight percent based on the total weight of the process cheese-type product.

13. The method of claim 12 wherein the additional moisture is approximately 1 to 4 percent based on the total weight of the process cheese-type product.

14. The method of claim 10 wherein the additional moisture is at least 0.10 weight percent based on the total weight of the process cheese-type product.

15. The method of claim 10 wherein the additional moisture is 1 to 4 percent based on the total weight of the process cheese-type product.

16. The process cheese-type product produced by the method of claim 10.

17. A process cheese-type product having been subjected to a shear rate of at least approximately 500 reciprocal seconds and having an amount of additional moisture of at least 0.1 weight percent while exhibiting substantially the same organoleptic and physical properties as a process cheese-type product without the additional moisture of at least 0.10 weight percent.

18. The process cheese-type product of claim 17 wherein the additional moisture is approximately 1 to 4 weight percent.

19. The process cheese-type product of claim 17 wherein the shear rate is at least approximately 1400 reciprocal seconds.

20. The process cheese-type product of claim 17 wherein the organoleptic and physical properties include melting properties and wherein the process cheese-type product exhibits the same melt properties as a process cheese-type product without the additional moisture.

21. The process cheese-type product of claim 17 wherein the organoleptic and physical properties include penetration and the process cheese-type product exhibits the same penetration properties as a cheese or cheese product without the additional moisture as defined by penetrometer AACC method 58-14 of the American Association of Cereal Chemist.

22. The process cheese-type product of claim 17 exhibiting no excessive stickiness or tearing or meaningless according to the procedure described in “Process Cheese” by Zehren and Nusbaum, 1992, pages 302-304.

23. A process cheese-type product as in claim 17 wherein the moisture incorporation is a result of the accumulated effects of repeatedly subjecting the process cheese-type product formula material to multiple passages through a shear device.
